(19) United States
(12) Patent Application Publication
(10) Pub. No.: US 2012/0088057 A1
(43) Pub. Date: Apr. 12, 2012

(54) CLOTHING PRODUCT TO REDUCE HYPOTHERMIA

(76) Inventors: Randy Meirowitz, San Diego, CA (US); Jamie A. Henderson, Temecula, CA (US)

(21) Appl. No.: 12/900,377

(22) Filed: Oct. 7, 2010

(51) Int. Cl. B32B 3/26; B32B 7/14; B32B 27/12; B32B 7/02

(52) U.S. Cl. 428/76; 428/304.4; 428/196; 428/319.3; 428/318.4

(57) ABSTRACT

The present invention provides multilayer structure to be worn by a wearer to reduce the incidence of hypothermia, the multilayer structure comprising a semi-permeable membrane, and a very low absorption fabric coupled to an outside surface of the very low absorption fabric, wherein the very low absorption fabric comprises an encapsulated fabric having a plurality of fibers and interstices, wherein the plurality of fibers are encapsulated by a polymer, and wherein, the plurality of interstices are tilled with the polymer.

### TECHNICAL FIELD

The present invention relates to a multilayer structure to be worn by a wearer to reduce the incidence of hypothermia.

### DESCRIPTION OF THE RELATED ART

Historically the outerwear industry has relied on harriers to solve the problem of wetness. That is, for a fabric coated fabric, or laminated fabric, the property of interest was its resistance to water penetration. This is measured by various tests involving the amount of hydrostatic pressure a material can keep from penetration. This resistance to penetration of water has given rise to material designations of water resistance and water proofness. While there has been recognition that the material must be breathable (be able to pass moisture vapor) in order to prevent liquid (water) build-up inside the outerwear article, there has been little recognition and testing with respect to the impact of moisture absorption by the material.

In view of the above, existing outerwear materials do not necessarily have low absorption and therefore tend to have a high heat loss associated therewith, leaving the wearer dry but cold. Historical materials achieve this barrier by various methods including: (i) highly constructed (tightly woven) fabrics, (ii) coating a film onto a fabric, (iii) laminating a film onto a fabric, (iv) mechanically compressing a fabric (cold or hot calendaring), (v) use of fluorochemical or other water repellant treatments, and (vi) various combinations of two or more of the above approaches. Such materials are not designed to minimize the absorption of water and therefore the heat loss associated with the wet fabric.

### BRIEF SUMMARY OF EMBODIMENTS OF THE INVENTION

One embodiment of the invention is directed toward a multilayer structure to be worn by a wearer to reduce the incidence of hypothermia, the multilayer structure comprising a semi-permeable membrane, and a very low absorption fabric coupled to an outside surface of the very low absorption fabric. The semi-permeable membrane comprises a highly moisture vapor permeable and highly water resistant barrier, wherein air is permitted to penetrate into and out of the semi-permeable membrane, and wherein liquids that penetrate through the very low absorption fabric are blocked by the semi-permeable membrane and are not absorbed by the very low absorption fabric. Moisture vapor is forced to move away from the wearer and through the semi-permeable layer and very low absorption fabric. In further embodiments of the invention, the semi-permeable membrane is adapted to be substantially windproof.

According to the invention, any very low absorption fabric may be employed. In some embodiments of the invention, the very low absorption fabric comprises a polyester fabric having an absorption (AATCC-70: ISO 9865) of <10% @0 wash (AATCC 135 method) <20% 5 wash, and <30% @10 wash. In other embodiments, the very low absorption fabric comprises a nylon fabric having an absorption of <15% @0 wash, <25% @5 wash, and <35% @110 wash. In further embodiments, the very low absorption fabric comprises a cotton fabric having an absorption of <25% @0 wash, <40% @5 wash, and <75% @10 wash.

According to further embodiments of the invention, the very low absorption ffibric comprises an encapsulated fabric having a plurality of fibers and interstices, wherein the plurality of fibers are encapsulated by a polymer, and wherein the plurality of interstices are filled with the polymer. In some such embodiments, the very low absorption fabric comprises a polyester fabric having an absorption of <5% @0 wash, <15% @5 wash, and <25% @10 wash. In other such embodiments, the very low absorption fabric comprises a nylon fabric having an absorption of <10% @0 wash. <20 @5 wash, and <30 @0 wash. In further such embodiments, the very low absorption fabric comprises a cotton fabric having an absorption of <20% @0 wash, <30 @5 wash, and <50 @10 wash.

According to some implementations of the multilayer structure, the semi-permeable membrane comprises a planar structure that has a hydrostatic resistance of ≧2 psi and an MVTR (Moisture Vapor Transport Rate—ASTM E-96 B) of ≧1000 g/m2/day. For example, the semi-permeable membrane may comprise a fabric with a hydrostatic resistance of >2 psi and an MVTR (ASTM. E-96 B) of ≧1200 g/m2/day. Alternatively, the set permeable membrane may comprise a film with a hydrostatic resistance of >3 psi and an MVTR (ASTM E-96B) of >1400 g/m2/day.

In some embodiments of the multilayer structure, the very low absorption fabric is bonded to the semi-permeable membrane using pattern bonding. In further embodiments, the very low absorption fabric is bonded to the semi-permeable membrane using adhesive spot bonding.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram illustrating an apparatus and method in which the invention can be implemented.

FIG. 2 illustrates a wash basin including a bath tub filled with water 215, a faucet and a drain, wherein the water in the tub represents the wearer's body temperature, the drain represents the energy loss from evaporation and thermal conductivity, and the water being put back into the tub via the faucet represents the body's heat from energy stores.

FIG. 3 illustrates a multilayer structure to be worn by a wearer including a very low absorption fabric coupled with a semi-permeable membrane, in accordance with the principles of the invention.

FIG. 4 illustrates a multilayer structure to he worn by a wearer including a normal fabric coupled with a semi-permeable membrane.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward a multilayer structure to be worn by a wearer to reduce the incidence of hypothermia, the multilayer structure comprising a semi-permeable membrane, and a very low absorption fabric coupled to an outside surface of the very low absorption fabric. The semi-permeable membrane comprises a highly moisture vapor permeable and highly water resistant barrier, wherein air is permitted to penetrate into and out of the semi-permeable membrane, and wherein liquids that penetrate through the very low absorption fabric are blocked by the semi-permeable membrane and are not absorbed by the very low absorption fabric. Moisture vapor is forced to move away from the wearer and through the semi-permeable layer and very low absorption fabric. In further embodiments of the invention, the semi-permeable membrane is adapted to be substantially windproof.

According to the invention, any very low absorption fabric may be employed in the above-described multi-layer structure. By way of example, but not meant as limiting, in some cases, the very low absorption fabric may comprise an encapsulated fabric having a plurality of fibers and interstices, wherein the plurality of fibers are encapsulated by a polymer, and wherein the plurality of interstices led with the polymer. Such a very low absorption encapsulated fabric may be manufactured by way of the following apparatus and method.

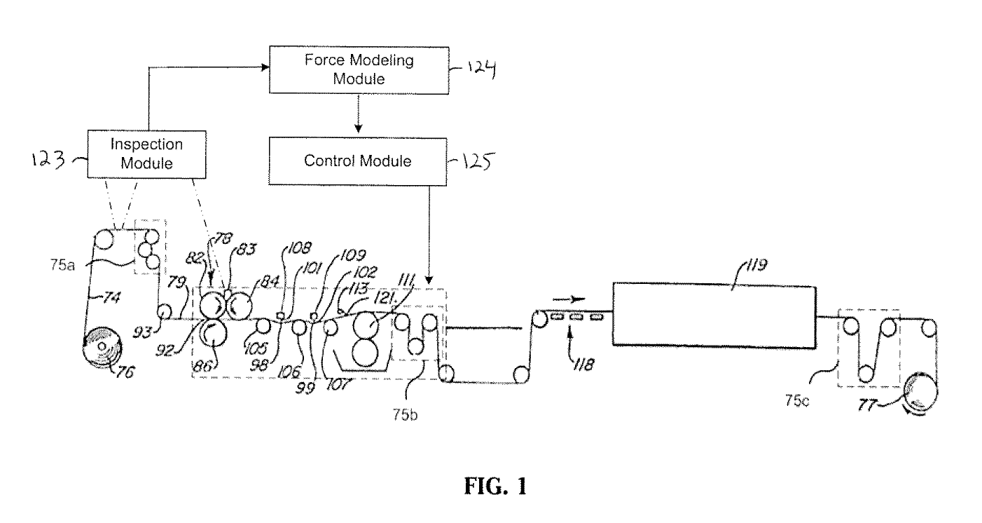

FIG. 1 illustrates a schematic of an apparatus 100 in which the present invention is being implemented according to an embodiment of the present invention. Referring now to FIG. 1, apparatus 100 includes a continuous web 74 that is being moved along a web pathway from a supply roll 76 to a take-up roll 77. Apparatus 100 further includes web tensioning devices 75a-c, a coating or encapsulating station 78, shear-knifes or blades 101 and 102, tenter frame 118, oven 119, inspection module 123, force modeling module 124, and control module 125.

Coating station 78 is configured to apply a polymer composition to the upper 79 of web 74 by a polymer applicator such as a conventional reverse roll coater 81. In the reverse roll coater 81 the polymer composition is applied to the surface of a reversely rotating coating roll 82 from a nip region reservoir 83 formed between the coating roll 82 and a transfer roll 84 (which rotates in the direction of travel of web 74, but whose surface does not contact web 74). The web 74 is transversely compressed between coating roll 82 and drive roll 86 as it passes through station 78. Thus, in one embodiment, the polymer composition is applied under a positive pressure against face 79 by coating roll 82 which functions to cause the composition to be forced into web 74. Alternatively, polymer composition may be applied to the upper face 79 of the web 74 without any force, leaving the controlled placement and shear thinning for a subsequent step or series of steps, such as by the fierce of the shear blades 101 and 102 as described below.

Largely for purposes of controlling the alignment of web 74 with rolls 82 and 86, the web 74 is pre-tensioned by tensioning devices 75a. In one embodiment, tensioning devices 75a are components of a conventional web clutching mechanism which provides selective tensioning of web 74 prior to a nip region 92 defined between rolls 82 and 86 with the intervening roller 93 being used for guidance of web 74. After passing nip region 92 the web 74 is controllably longitudinally tensioned along the web pathway extending from nip region 92 to tensioning devices 75b. The tensioning devices 75b are components of conventional web tension adjusting and regulating device which provides for on-line, in stream operator controlled adjustments that permit selective control of the tautness of web 74 particularly in the web pathway region from nip region 92 to tensioning devices 75b.

Along the tensioned web pathway region, the web 74 successively passes through one or more of a series of processing area 98, 99 and 121. At each of the stations 98 and 99, a substantially non-flexible shear blade 101 and 102, respectively, extends laterally across web 74 with the web 74 being entirely unsupported on the lower face thereof which is opposed to upper face 79 and to the respective blade of shear blades 101 and 102. To control the amount and type of shear force independently applied by each blade 101 and 102, the web 74 passes over each blade edge in a contacting contacting relationship and three blade rolls 105, 106 and 107. Rolls' 105-107 position may be adjustable relative to blades 101 and 102. The blades 101 and 102 are also adjustable both vertically and angularly. By adjusting the vertical height of each blade relative to the web path or the web path's position relative to each blade, the force of each blade against the web can be controlled. By adjusting the vertical height of the blade rolls, the shear force can be controlled and the angle at which he web contacts the blades can also be controlled.

In one embodiment, blade rolls 105 and 106 can be positioned such that roll 105 is on the lead side, and roll 106 on the trailing side, of blade 101 while blade rolls 106 and 107 are positioned so that roil 106 is on the lead side, and roll 107 is on the trailing side of blade 102. The angle of inclination or tilt of each blade 101 and 102 relative to the vertical is adjustable over a wide range, but it is presently preferred to adjust the blade inclination angle for each blade between about ±45° relative to the vertical with the web 74 being horizontal. In one embodiment, each respective blade is functionally associated with a blade back support or holder 108 and 109, respectively. Each support 108 and 109 permits its associated blade 101 and 102 to be vertically and angularly positioned relative to a supporting frame (not shown).

Those skilled in the art will appreciate that the amount of shear force applied by one or more shear blades 101 or 102 transversely against a web 74 is a function of many variables with probably the most important principal variables being the polymer viscosity, the longitudinal web tension, and the positioning of the shear knives 101 and 102 relative to the web 74 during operation.

In one embodiment, the temperature of the blade can he kept cool to keep the polymer composition from curing prematurely. This can be accomplished by passing a coolant through or around the blade or by other means well known in the art. Alternatively, the blade could be heated by passing a heated fluid around or through the blade, if desired to improve or alter he viscosity and rheology for the required changes in the polymer necessary to achieve a specific product.

In one embodiment, changing the tension of the web can result changes internally to the web such as, for example, the position of the internal layer of the web, amount of fiber encapsulation, and thickness of the film encapsulating the individual fibers or filaments.

At the leading edge of the blade, the web is stretched longitudinally and the polymer is simultaneously and dynamically shear thinned, placed into the web, and partially extracted from the web, thereby leaving encapsulated fibers and filaments and/or an internal layer. As the web passes the leading edge of the blade, the elastic recovery forces of the web combined with the relaxation or elan very of the fibers and filaments causes fiber encapsulation and the surface chemistry modification (or bloom). The fibers and filaments either pull the polymer from the interstitial spaces or the rheology of the polymer attracts it to the fibers and filaments or some combination of the two. The end result is that the polymer in the interstitial spaces moves to the fibers and filaments as they move or snap apart, thereby creating encapsulated fibers and filaments.

In one embodiment, after leaving tensioning devices 75b, web 74 is under reduced or preferably minimal tension and is led into oven 119 via tenter frame 118. Distortions or other defects in the web may exist at this point in the process. These distortions can be metered and observed and then the tenter frame 118 can be adjusted such that the web can be straightened or shaped either longitudinally or laterally, as desirable or considered necessary for an individual web. If desired, the tenter frame 118 can be automatically operated to apply tensioning forces to a web in accordance with a predetermined program, or the like. The tenter frame 118 can also provide the start of a new zone of limited longitudinal and transverse tensioning which extends forwardly along the web pathway from tenter frame 118 through oven 119 to a tension compensator, here shown as utilizing three tensioning device 75c which are part of a conventional mechanical tension compensator subassembly which is similar in structure and function to the compensator subassembly incorporating the previously described tensioning devices 75b.

The oven 119 functions to cure the polymer composition selectively placed within the web 74. Oven 119 can be operated with gas or other energy source. Furthermore, the oven could utilize radiant heat, induction heat, convection, microwave energy or other suitable means for affecting a cure which are known in the art. Oven 119 can extend for from about 12 to about 20 yards. Curing temperatures range from about 320° to about 500° F., applied for times of from about 2 minutes to about 30 seconds (depending upon the temperature and the polymer composition) are desirable. If a curing accelerator is present in the polymer, curing temperatures can be dropped down to temperatures of about 265° F. or even lower (with times remaining in the range indicated).

The take-up roll 77 is operating at approximately the same speed as the supply roll 76. When the rotational speeds of take-up roll 77 are not synchronized with rotational speeds of the supply roll 76, the tension roll combination of rolls 121, 122 and 123 can be used to take up or reduce web slack, as the case may be.

As silk n in FIG. 1, apparatus or environment 100 also includes one or more inspection modules 123, force modeling module 124, and control module 125. Inspection modules can be set up at various locations in environment 100 to measure or obtain characteristics of the web and other materials such as, for example, materials used for encapsulating web 74. For example, inspection module 123 can be configured to measure or estimate various characteristics of web 74 such as thickness, porosity, strength, temperature, and weight. Inspection module 123 can also be configured to measure or estimate various characteristics of the encapsulation material such as, for example, viscosity and temperature. These measured characteristics can then be forwarded to force modeling module 124.

Force modeling module 124 is configured to generate operating parameters for controlling one or more components of apparatus 100 such as, for example, components located inside of a zone 151, as shown in FIG. 1, based on one or more characteristics of the web, the encapsulating material, or a desired characteristic of an encapsulated web, which can be manually inputted into module 124. The generated operating parameters may be used to do one or more of the following: change the height of blade 101 or 102 with respect to a reference point; change the vertical position of one or more of rollers 105, 106, and 107; change the angle of blade 101 or 102 with respect to a vertical reference; change the speed of rollers 82, 84, 86, 105, 106, and 107; and change the temperature of any one of the rollers. Module 124 is configured to generate recommended operating parameters such that a predetermined (approximate) amount of force normal of to the web is generated at each of the first and second blades. The force selected by module 124 is based on the measured characteristics collected by inspection module 123. In this way, the encapsulated web produced may have the desired characteristics.

To obtain a certain normal force at each blade, module 124 may control one or more of the following variables in environment 100: 1) web tension, 2) angle of entry of fabric into the blade, 3) blade angle in reference to horizontal position, 4) blade height, 5) angle of exit of fabric from blade, 6) web speed, 7) viscosity of polymers, 8) nip pressure, 9) entry nip pressure 10) oven cure temperature, 11) oven cure dwell time, 12) ambient polymer temperature, 13) humidity, and 14) degree web is deformed under lateral tension. Control module 125 is configured to carry out the process changes once the operating parameters and variables are generated by force modeling module 124.

Modules 123, 124, and 125 can be configured to be fully automated, meaning materials characteristics and process conditions are constantly monitored and, operating parameters can be automatically changed in response to the monitoring process.

A curable polymer such as used in the practice of this invention is applied under pressure using shear forces onto and into a web or substrate. The shear forces cause the curable silicone polymer to flow into the web. The extent of fiber envelopment and cell or pore wall lining is believed to be regulatable by controlling such factors as discussed previously, as well as the selection and applied amount of fluorochemical, if any, the curable polymer used, and the applied compressive and shear forces employed at a given temperature so that fiber envelopment is achieved while the interstices and/or open cells of the web are not completely filled with such polymer in the region of the internal layer, and the outer opposed surfaces of the web are substantially completely free of polymer coating or residue. After such a procedure, the curable polymer is then cured.

The curable polymer is applied onto the surface of the web. Then, the web, while tensioned, is passed over and against shearing means or through a compression zone, such as between rollers or against a shear blade. Thus, transversely applied shear force and compressive pressure is applied to the web. The combination of tension, shearing forces, and web speed is sufficient to cause the polymer to move into the web and out from the interstices or open cells around the web fibers, cells, or pores being enveloped. The result is that at least some of the interstices and/or open cells are unfilled in regions of the web outside of the region occupied by the internal coating or internal layer, and are preferably substantially free of polymer. Excess polymer is removed by the surface wiping action of the shearing means. The curable polymer enveloping the fibers is thereafter cured.

Other variables that affect the finished product, but are not directly related to the methods and apparatus, include, without limitation, the polymer blend, the starting viscosity of the polymer composition, accelerators added to the polymer composition, additives to the polymer composition, the type of web used, ambient temperature, humidity, airborne contaminants, lint on web, pre-treatment of web, sub-web surface temperature, and web moisture content.

For in depth understanding of encapsulation process, it is essential to have sonic key knowledge of fabric structure. Fabric structure is so important that most failures in product development can be attributed to improper fabric structures and its pre-finish treatment. For the coating of a porous substrate (coating processes have many similarities as our encapsulation technology), pore size, shape, and distribution (including connectivity) of a porous material may be the most interested structural properties. Woven fabric is generally considered to be a porous substrate due to the existence of interstitial spaces between warp and till yarns and capillaries between filament bundles. In order to understand the details of the effect of fabric structure on encapsulation, fabric structure is defined in a more general way below.

Structure of a fabric is defined as above since it is believed flow behavior of a polymer is quite different at the exposure surface region and inside of the fabric. Such a definition will help us in understanding of concept of Weight Add On (WAO) and polymer placement on and/or inside a fabric. Inside a fabric, polymer flow can be simply treated as one dimensional flow described by Darcy's law: q=−kΔp/ηΔx, i.e. locally the volumetric flux per unit total cross-section of material q is proportional to the negative of the mechanical potential gradient, of which only the pressure gradient Δp is relevant here, and is inversely proportional to the liquid's (liquid silicone rubber for our case) viscosity. η. The proportionality constant is the permeability of the material to the liquid, k. The permeability, k, is mainly dependent on size and shape of pores inside the fabric. In deformable porous media such as a fabric undergoing compression (hydrodynamic pressure) and expansion (fabric recovery after release of the hydrodynamic pressure), the size and shape of pore may change.

Since the size of molecules in air is fairly small, their transmitting rate through a fabric is mainly controlled by the total percentage of pores and connectivity of those pores. For any given fabric, of air paths in the fabric and total surface area covered by the polymer increase with increasing WAO. Therefore, under atmospheric or limited pressure, air permeability will decrease with increasing WAO. When polymers with different viscosities are used, the air permeability will be affected not only by the total WAO but also by the depth of polymer penetration inside a fabric. For example, Mirage (a product produced by Nextee Applications Inc., Greenwich, Conn.) encapsulated with GE 6108 (high viscosity) always has a higher air permeability than that encapsulated with DC 4-1440 (low viscosity) at the same total WAO. The effect of polymer penetration inside a fabric on air permeability is so dramatic that, for the same level of MVTR, only half amount of WAO is needed if DC 4-1440 is used to replace GE 6108. Obviously, the high efficiency of air blocking of DC 4-1440 is attributed to its deeper penetration inside the fabric yarns.

Theoretically, anything that decreases air permeability should also decrease water permeability (or increase water resistance). However, since water resistance is characterized by the hydrodynamic pressure needed to push a water drop through a fabric (AATCC 127—Suter Test), the water resistance is not only dependent upon how many water paths are blocked but also on how strong the blocking materials are. The strength of the encapsulated polymer is contributed from both the film thickness and restrictions on the deformability of the films. Generally speaking, the higher the WAO, the higher the water resistance since film thickness increases with increasing WAO. However variation of water resistance as a function of WAO is not necessarily linear, instead, a S-type curve is observed for the limited cases studied, such as Mirage and Solitude (a product produced by Nextec Applications Inc., Greenwich, Conn.). Based on the shape of the Suter—WAO curve, three WAO ranges at which Suter responds differently are identified. At a low WAO range (the actual upper limit varies with the fabric and silicone), there is no enhancement of Suter performance; instead, Suter is even lower than that of corresponding raw fabric. At an intermediate WAO range, Suter increases dramatically with increasing WAO. At high WAO, the rate of Suter increase slows down.

A common question among glove wearers is: my gloves are wet and my fingers dry; why are they cold? Hypothermia is a drop in the core body temperature. In stage 1 hypothermia, the body temperature drops by 1-2° C. below normal. Even this much of a drop in core body temperature results in constriction of blood vessels in the outer extremities, mild to strong shivering, numbness, inability to perform complex tasks with the hands, and quickened or shallow breathing. A 5° C. drop in core body temperature below normal typically results in death. Flow do one's clothes affect body temperature?. There are many variables that affect this situation. In the simplest sense, two which need to be considered evaporation and thermal conductivity.

With respect to evaporation, it takes 1 calorie (4.18 Joules) to raise the temperature of one gram of water by 1° C. However, it takes about 540 times as much energy to evaporate that same gram of water (change from liquid to vapor phase). The reasons for this are well known and well understood (see, e.g., A. W. Adamson, A Textbook of Physical Chemistry—intermolecular interactions, hydrogen bonding, etc). The energy required for raising or lowering the temperature of one gram of human body tissue is about 0.85 times as much as for water. It takes significantly more energy to evaporate one gram of water from the surface of the body than it takes to lower the temperature of one gram of body tissue by 1° C. The energy required for the evaporation of water absorbed by a garment is taken from the body of the wearer. Therefore, we can look at the energy cost to evaporate different amounts of water in the wearer's garments and calculate how much heat would he lost from the body of the wearer.

In a particular example, two identical jackets (same weight and same design) are worn by two identical people (same weight) in identical conditions (raining). If the amount of water each jacket absorbs is different, does this make a difference to the wearer? If all the water absorbed by the jackets was evaporated this would require a certain amount of energy. If all this energy was supplied by the body of the wearer, what would be the equivalent temperature drop?

Given: Jacket weight 350 grams
Absorption (%) Jacket I (25%)*; Jacket II (3%)^{†}
Body weight of person wearing jacket 65 kg
Specific heat capacity human body=3.538 J/gram•° C.=0.85 cal/gram•° C.
65 kg=65,000 g
   * The 25% absorption is taken as an average from many conventional membrane (coated and laminated) garments
   †The 3% is taken as an average from many EPIC encapsulated garments

### Water Absorbed

| Jacket I | Jacket II |
|---|---|
| 87.5 grams water | 10.5 grams water |

Energy to evaporate water ΔH_{fus}=2257 J/g=539 cal/g

For example: Jacket I
Temperature change energy would cause in a 65 kg person

In conclusion, the amount of energy cost to the body is approximately 9 times greater for evaporation from the jacket with 25% absorption.

Heat radiates out from a surface. Body heat must pass through the wearer's garment. The thermal conductivity of the garment, or how well it conducts heat, is a large factor in how quickly heat is carried away from the body. The thermal conductivity of dry air is 0.024 W/m° C. The thermal conductivity of water is 0.58 W/m° C. This means that water conducts heat 24.2 times better (faster) than air. The jacket with 3% absorption carries less water than the jacket with 25% absorption. As a result, the jacket with 25% absorption will conduct heat away from the body faster.

The greater the absorption of a garment, the more radiative heat is lost from the body of the wearer. This means that in wet conditions the wearer will be colder and at a greater risk for hypothermia in many conventional membrane (coated and laminated) garments than the wearer would be in an encapsulated low absorption material such as described herein. So, the answer to the question—my gloves wet and my fingers dry; why are they cold?—is that the amount of energy (body heat) required to evaporate the water n the garment is greater he wetter the garment. This is exacerbated by the fact that the wetter the garment, the faster heat radiates away from the wearer through the garment.

The picture painted above is one in which a set amount of energy is use to evaporate a set amount of water, and radiative heat loss is added to that amount of energy. Further, in the above example it is shown how much a body's temperature would decrease from a given amount of heat energy lost. However, it is much worse than that. While the good news is the body uses energy stores to keep its core temperature constant, this may not be sufficient. In this scenario, it appears that the body would burn all its energy stores before beginning to lose core body temperature, but that is not the case. By way of illustration, if a bathtub is filled with water and the drain is opened, water will begin to flow out of the tub. The bigger the drain, the faster the water goes out. One can turn on the tap to replace the water that is going down the drain, but if it is going down the drain faster than the tap can supply additional water, the tub will still lose water.

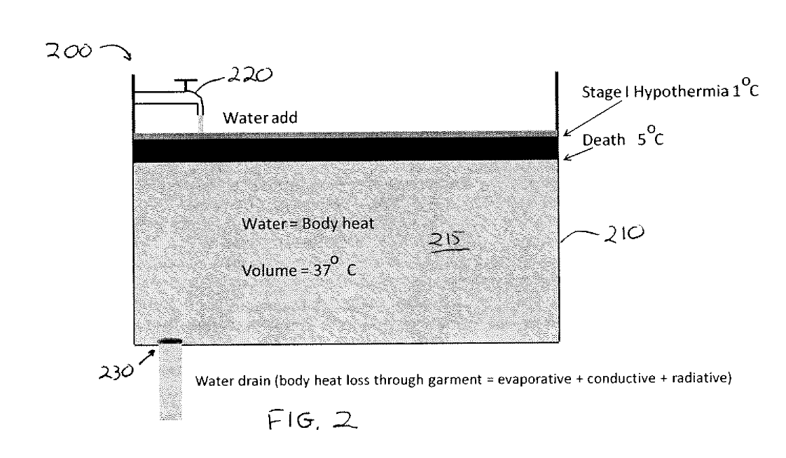

Referring to FIG. 2, a wash basin 200 is depicted including a bath tub 210 filled with water 215, a faucet 220 and a drain 230. In this depiction, the water 215 in the tub 210 represents is the wearer's body temperature, the drain 230 represents the energy loss from evaporation and thermal conductivity, and the water being put back into the tub via faucet 220 represents the body's heat from stores. As stated, the bigger the drain 230 the faster the tub 210 (i.e., the wearer's body) loses water. As conditions get colder wetter, the drain gets bigger. The more water a garment absorbs, the more heat is drained from the body. This gets point where the body cannot replace the heat by burning energy stores as fast as it is leaving the body, and the core body temperature begins to drop. Given that the bath tub 210 represents a body temperature of 37° C., then death occurs well before the tub 210 is empty. In fact, death occurs when the tub 210 has lost only about ⅛^{th} of its water. Stage 1 hypothermia—which entails a constriction of blood vessels in the outer extremities, mild to strong shivering, numbness, inability to perform complex tasks with the hands, and quickened or shallow breathing—begins when the tub 210 has lost only 1/37^{th} of its water.

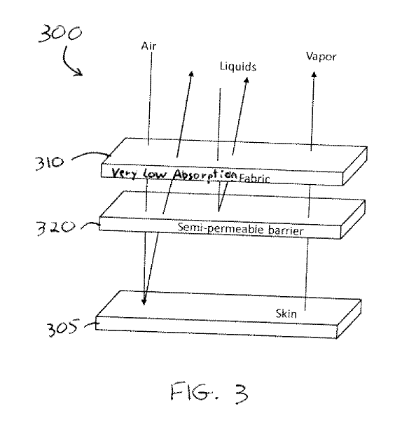

Referring to FIG. 3, various embodiments of the present invention comprise a multilayer structure 300 to be worn by a wearer having skin 305, the multilayer structure 300 including a very low absorption fabric 310 coupled with a semi-permeable membrane 320. Such a very low absorption fabric may be manufactured using the apparatus and methods described hereinabove with respect to FIG. 1. In some embodiments, the semi-permeable membrane 320 comprises a highly moisture vapor permeable and highly water resistant barrier. As illustrated in FIG. 3, the resultant multilayer structure 300 (i) allows air to penetrate into and go out of the outerwear material, (ii) allows liquids that penetrate through the fabric layer to be blocked by the membrane and not be absorbed by the fabric, and (iii) forces moisture vapor to move from the body to the outside. Consequently, the multilayer structure 300 keeps the wearer dry without losing body heat through evaporative or conductive heat loss.

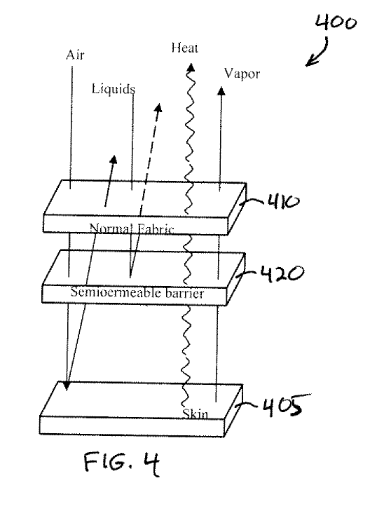

By contrast, the multilayer structure 400 depicted in FIG. 4 comprises a normal fabric 410 coupled to the semi-permeable membrane 420, wherein the normal fabric 410 is not a very low absorption fabric. In this multilayer structure 400, the harrier (i.e., semi-permeable membrane 320) blocks the water, but the fabric 410 absorbs this water, which then must evaporate (as symbolized by the dotted line). As the water evaporates (i.e., turns to vapor), it steals body heat from the wearer to cause the phase transition from liquid to vapor water.

With further reference to FIG. 3, the very low absorption fabric 310 may comprise any fabric with low absorption. For example, the very low absorption fabric 310 may comprise a polyester fabric having an absorption of about <10% @0 wash, about <20% @5 wash, and about <30% @10 wash. Alternatively, the very low absorption fabric 310 may comprise a nylon fabric having an absorption of about <15% @0 wash, about <25% @5 wash, and about <35% @10 wash. As a further example, the very low absorption fabric 310 may comprise a cotton fabric having an absorption of about <25% @0 wash, about <40% @5 wash, and about <75% @10 wash. In one preferred implementation of the invention, the very low absorption fabric 310 comprises an encapsulated fabric such as described herein, wherein: (i) the absorption fur a polyester fabric is about <5% @0 wash, about <15 @5 wash, and about <25% @10 wash; (ii) the absorption for a nylon fabric is about <10% @0 wash, about <20 @5 wash, and about <30 @10 wash; and (iii) the absorption for a cotton fabric is about <20% @0 wash, about <30 @5 wash and ab <50 @10 wash.

According to various embodiments of the inventmon, the semi-permeable membrane 320 may comprise any planar structure that has a hydrostatic resistance of about ≧2 psi and an MVTR (ASTM E-96 B) of about ≧1000 g/m2/day. One preferred implementation comprises a fabric with a hydrostatic resistance of about >2 psi and an MVTR (ASTM E-96 B) of about ≧1200 g/m2/day. Another preferred implementation comprises a film with a hydrostatic resistance of about >3 psi and an MVTR (ASTM E-96 B) of about >1400 g/m2/day

With further reference to FIG. 3, the very low absorption fabric 310 may be bonded to the semi-permeable membrane 320 by any suitable type of bonding that acts to adhere the two layers without interfering with the desired properties of the resultant multilayer structure 300. By way of example, the very low absorption fabric 310 may be bonded to the semi-permeable membrane 320 using thermal bonding (for thermoplastic materials) such as pattern bonding. Alternatively, the layers may be bonded by way of adhesive bonding, with the adhesive chosen to have adequate bonding to both substrates. In one preferred implementation, the layers are bonded by way of adhesive spot bonding.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also he read as “and/or” unless expressly stated otherwise. Furthermore, although items, elements or components of the invention may be described or claimed in the singular, the plural is contemplated to be within the scope thereof unless limitation to the singular s explicitly stated.

The presence of broadening words and phrases such as “one or more,” “at least,” “hut not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed any or all of the various components of a module, whether control logic or other components, can be combined in a single package or separately maintained and can further he distributed across multiple locations.

While various embodiments of the present invention have been described above it should he understood that they have been presented by way of example only, and not of limitation. Likewise, the various diagrams may depict an example architectural or other configuration for the invention, which is provided to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be used to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments he implemented to perform the recited functionality in the same order unless the context dictates otherwise.

Although the invention is described above in terms of various exemplary embodiments and implementations, it should he understood that the various features, aspects and functionality described in one or more of the individual embodiments are not limited in their applicability the particular embodiment with which they are described, but instead can he applied, alone or in various combinations, to one or more of the other embodiments of the invention, whether or not such embodiments are described and whether or not such features are presented as being a part of a described embodiment. Thus, the breadth and scope of the present invention should not he limited by any of the above-described exemplary embodiments.

Terms and phrases used in this document, and variations thereof, unless otherwise expressly stated, should be construed as open ended as opposed to limiting. As examples of the foregoing: the term “including” should he read as meaning “including, without limitation” or the like; the term “example” is used to provide exemplary instances of the item in discussion, not an exhaustive ng list thereof; the terms “a” or “an” should be read as meaning “at least one,” “one or more” or the like; and adjectives such as “conventional,” “traditional,” “normal,” “standard,” “known” and terms of similar meaning should not he construed as limiting the item described to a given time period or to an item available as of a given time, but instead should he read to encompass conventional, traditional, normal, or standard technologies that may be available or known now or at any time in the future. Likewise, where this document refers to technologies that would he apparent or known to one of ordinary skill in the art, such technologies encompass those apparent or known o the skilled artisan now or at any time in the future.

Additionally, the various embodiments set forth herein are described in terms of exemplary block diagrams, flow charts and other illustrations. As will become apparent to one of ordinary skill in the art after reading this document, the illustrated embodiments and their various alternatives can he implemented without confinement to the illustrated examples. For example, block diagrams and their accompanying description should not he construed as mandating a particular architecture or configuration.

1. A multilayer structure to be worn by a wearer to reduce the incidence of hypothermia, the multilayer structure comprising:
a semi-permeable membrane; and
a very low absorption fabric coupled to an outside surface of the very low absorption fabric.

2. The multilayer structure of claim 1, wherein the semi-permeable membrane comprises a harrier having a higher MVTR and water resistance than the low absorption fabric.

3. The multilayer structure of claim 1, wherein air is permitted to penetrate into and out of the semi-permeable membrane.

4. The multilayer structure of claim 1, wherein liquids that penetrate through the very low absorption fabric are blocked by the semi-permeable membrane and are not absorbed by the very low absorption fabric.

5. The multilayer structure of claim 1, wherein moisture vapor is forced to move away from the wearer and through the semi-permeable layer and very low absorption fabric.

6. The multilayer structure of claim 1, wherein the very low absorption fabric comprises a polyester fabric having an absorption of <10% @0 wash, <20% @5 wash. and <30% @10 wash.

7. The multilayer structure of claim 1, wherein the very low absorption fabric comprises a nylon fabric having an absorption of <15% @0 wash, <25% @5 wash, and <35% @10 wash.

8. The multilayer structure of claim 1, wherein the very low absorption fabric comprises a cotton fabric having an absorption of <25% @0 wash, <40% @5 wash, and <75% @10 wash.

9. The multilaver structure of claim 1, wherein the low absorption fabric comprises an encapsulated fabric having a plurality of fibers and interstices, wherein the plurality of fibers are encapsulated by a polymer, and wherein the plurality of interstices are filled with the polymer.

10. The multilayer structure of claim 9, wherein the very low absorption fabric comprises a polyester fabric having an absorption of <5% @0 wash <15% @5 wash, and <25% @10 wash.

11. The multilayer structure of claim 9, wherein the very low absorption fabric comprises a nylon fabric having an absorption of <10% @0 wash, <20 @5 wash, and <30 @10 wash.

12. The multilayer structure of claim 9, wherein the very low absorption fabric comprises a cotton Fabric having an absorption of <20% @0 wash, <30 @5 wash, and <50 @10 wash.

13. The multilayer structure of claim 1, wherein the semi-permeable membrane comprises a planar structure that has a hydrostatic resistance of ≧2 psi and an MVTR (ASTM E-96 B) of ≧1000 g/m2/day.

14. The multilayer structure of claim 1, wherein the semi-permeable membrane comprises a fabric with a hydrostatic resistance of >2 psi and an MVTR. (ASTM E-96 B) of ≧1200 g/m2/day.

15. The multilayer structure of claim 1, wherein the semi-permeable membrane comprises a film with a hydrostatic resistance of >3 psi and an MVTR (ASTM E-96 B) of >1400 g/m2/day

16. The multilayer structure of claim 1, wherein the very low absorption fabric is bonded to the semi-permeable membrane using pattern bonding.

17. The multilayer structure of claim 1, wherein the very low absorption fabric is bonded to the semi-permeable membrane using adhesive spot bonding.

18. A multilayer structure to be worn by a wearer to reduce the incidence of hypothermia, the multilayer structure comprising:
a semi-permeable membrane; and
a very low absorption fabric coupled to an outside surface of the very low absorption fabric;
wherein the very low absorption fabric comprises an encapsulated fabric having a plurality of fibers and interstices, wherein the plurality of fibers are encapsulated by a polymer, and wherein the plurality of interstices are filled with the polymer;
wherein the semi-permeable membrane comprises a planar structure that has a hydrostatic resistance of ≧2 psi and an MVTR (ASTM E-96 B) of ≧1000 g/m2/day.

19. The multilayer structure of claim 18, wherein the very low absorption fabric is bonded to the semi-permeable membrane using pattern bonding.

20. The multilayer structure of claim 18, wherein the very low absorption fabric is bonded to the semi-permeable membrane using adhesive spot bonding.
